(19) United States
(12) Patent Application Publication
(10) Pub. No.: US 2023/0215716 A1
(43) Pub. Date: Jul. 6, 2023

(54) CURVED ION GUIDES AND RELATED SYSTEMS AND METHODS

(71) Applicants: PerkinElmer Health Sciences, Inc., Waltham, MA (US); PerkinElmer Health Sciences Canada, Inc., Woodbridge (CA)

(72) Inventors: Shawn Johnson, Shelton, CT (US); Edgar Lee, Shelton, CT (US); Hamid R. Badiei, Woodbridge (CA)

(21) Appl. No.: 18/150,314

(22) Filed: Jan. 5, 2023

Related U.S. Application Data
(60) Provisional application No. 63/297,072, filed on Jan. 6, 2022.

(51) Int. Cl. H01J 49/06

(52) U.S. Cl. CPC H01J 49/062; H01J 49/061

(57) ABSTRACT

An ion guide includes a plurality of lenses arranged in series along a curved central axis. Each lens includes a body and a central opening, and the central openings of the plurality of disks define a curved ion guide region. The ion guide includes an ion deflector configured to apply a radial DC electric field across the ion guide region and along the curved central axis. The ion deflector includes at least one DC voltage source that is configured to apply a positive DC voltage to at least some of the plurality of lenses and a negative DC voltage to at least some of the plurality of lenses.

### RELATED APPLICATIONS

This application claims priority from U.S. Provisional Application Ser. No. 63/297,072, filed Jan. 6, 2022, the disclosure of which is incorporated by reference in its entirety.

### BACKGROUND

One or more ion guides may be used for guiding ions from a given source to a given destination in an instrument such as a mass spectrometer. The ion guide may be curved to provide ion optics with a longer length and/or more compact footprint.

### SUMMARY

Some embodiments of the present technology are directed to an ion guide including a plurality of lenses arranged in series along a curved central axis. Each lens includes a body and a central opening, and the central openings of the plurality of lenses define a curved ion guide region. The curved ion guide region begins at an ion entrance and ends at an ion exit. The ion guide includes an ion deflector configured to apply a radial DC electric field across the ion guide region and along the curved central axis. The ion deflector includes at least one DC voltage source that is configured to apply a positive DC voltage to at least some of the plurality of lenses and a negative DC voltage to at least some of the plurality of lenses.

In some embodiments, the at least one DC voltage source is configured to apply DC voltage in a repeating pattern comprising applying one of a positive DC voltage and a negative DC voltage to a plurality of consecutive lenses in the series followed by applying the other one of a positive DC voltage and a negative DC voltage to at least one lens in the series that directly follow the plurality of consecutive lenses. The at least one lens may include a single lens in the series. The plurality of consecutive lenses may include at least three consecutive lenses in the series.

In some embodiments, the ion entrance and the ion exit define an angle of 90 or 180 degrees therebetween.

In some embodiments, each lens is disk shaped, and the body of each lens is continuous and surrounds the central opening. Each of the lenses may have an outer diameter of between 10 mm and 40 mm. The central opening of each of the lenses may have a diameter of between 2.5 mm and 8 mm.

In some embodiments, the lenses are spaced apart and electrically isolated from one another.

In some embodiments, the ion entrance and the ion exit define an angle of 90 degrees therebetween, and the plurality of lenses includes between 40 and 60 lenses.

In some embodiments, the at least one DC voltage source includes a plurality of DC voltage sources configured to simultaneously apply a positive DC voltage to at least some of the plurality of lenses and a negative DC voltage to at least some of the plurality of lenses.

Some other embodiments of the present technology are directed to an ion guide including a plurality of lenses arranged in series along a curved central axis. Each lens includes a body and a central opening, and the central openings of the plurality of lenses define a curved ion guide region. The ion guide includes an ion bending or deflecting device configured to bend ions along the curved ion guide region from the ion entrance to the ion exit only by DC voltage application and without applying an RF field.

Some other embodiments of the present technology are directed to a method for guiding an ion through an ion guide. The method includes: transmitting the ion into a curved ion guide region of the ion guide, the ion guide including a plurality of lenses arranged in series along a curved central axis, each lens including a body and a central opening, wherein the central openings of the plurality of lenses define the curved ion guide region, the curved ion guide region beginning at an ion entrance and ending at an ion exit; and providing an ion bending force to bend ions along the curved ion guide region from the ion entrance to the ion exit only by applying DC voltage to the plurality of lenses and without applying an RF field.

In some embodiments, providing an ion bending force includes applying a positive DC voltage to at least some of the plurality of lenses and applying a negative DC voltage to at least some of the plurality of lenses.

In some embodiments, providing an ion bending force includes applying DC voltage in a repeating pattern including applying one of a positive DC voltage and a negative DC voltage to a plurality of consecutive lenses in the series followed by applying the other one of a positive DC voltage and a negative DC voltage to at least one lens in the series that directly follow the plurality of consecutive lenses. The at least one lens may include a single lens in the series. The plurality of consecutive lenses comprises at least three consecutive lenses in the series.

In some embodiments, the method includes applying an equal DC voltage to each of the plurality of consecutive lenses in the series.

In some embodiments, the method includes applying varying DC voltages to the plurality of consecutive lenses in the series.

In some embodiments, the method includes concurrently or simultaneously applying a positive DC voltage to at least some of the plurality of lenses and applying a negative DC voltage to at least some of the plurality of lenses.

Further features, advantages and details of the present technology will be appreciated by those of ordinary skill in the art from a reading of the figures and the detailed description of the embodiments that follow, such description being merely illustrative of the present technology.

### BRIEF DESCRIPTION OF THE DRAWINGS

FIG. 1 is a schematic diagram of an example of an ion guide and an associated ion processing system according to some embodiments.

FIG. 2 is a top view of an example of a portion of an ion guide according to some embodiments.

FIG. 3 is a perspective view of the ion guide of FIG. 2.

FIG. 4 is an enlarged fragmentary perspective view of the ion guide of FIG. 2 and illustrating a lens of the ion guide.

### DETAILED DESCRIPTION

Mass spectrometry often uses turns to eliminate metastable molecules and other sources of noise for the system. Traditionally, ion path/optics design is axial/straight because it is much easier to manipulate ions in this direction. Bending an ion from its current trajectory/trying to deflect an ion along a curve can be challenging due to the kinetic energy of the ions. Bending/curving an ion guide, however, works to save space. Curved ion guides exist; however, an issue is that the energy is not the same for all the ions. Typically, curved ion guides use a quadripolar or multipolar design where an RF field is applied. The present inventors sought to develop a turn that has not yet been developed using DC voltage application and, in some embodiments, using DC voltage application and not using an RF field.

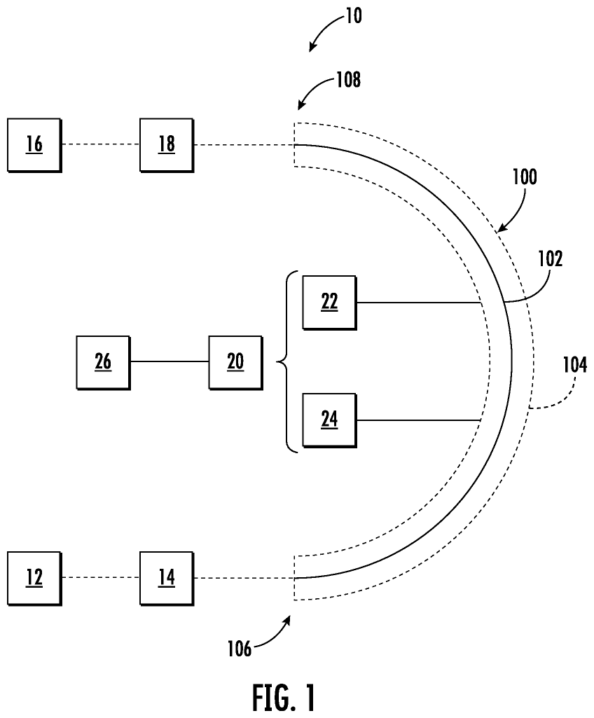

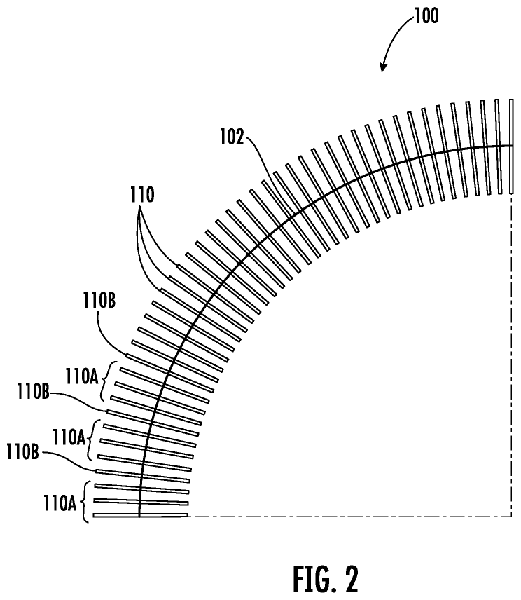

FIG. 1 schematically illustrates an example ion guide or ion guide assembly 100 that is included in an ion processing apparatus or system 10 according to some embodiments of the technology. The ion guide 100 may include a plurality of lenses (see, e.g., FIG. 2) arranged in series along a curved central axis 102. The ion guide 100 may include a housing or frame 104 and/or other structure suitable for supporting the lenses in a fixed arrangement along the central axis 102. In some embodiments, the housing 104 may provide an evacuated, low-pressure, or less than atmospheric pressure environment. The opposite axial ends of the ion guide 100 respectively serve as an ion inlet 106 and an ion outlet 108. As described in more detail herein, by the application of DC voltages to the lenses, the lenses generate a two-dimensional electrical restoring field that focuses ions generally along a curved path represented by the central axis 102. Only charged particles are influenced by the DC field, so when a particle stream including ions and neutral particles (e.g., gas particles, liquid droplets, etc.) enters the ion guide 100 via the ion inlet 106, the ions are constrained to motion in the vicinity of the central axis 102 while the neutral particles generally continue on a straight path. Therefore, only ions exit the ion guide 100 via the ion outlet 108.

The ion guides described herein may be utilized in any process, apparatus, device, instrument, system or the like for which a curved focused ion beam is contemplated for guiding ions from a given source to a given destination. The ion processing system 10 schematically illustrated in FIG. 1 may represent an environment in which the ion guide may operate. Thus, for example, the ion processing system 10 may generally include one or more upstream devices 12 and 14 and/or one or more downstream devices 16 and 18. The ion processing system 10 may be a mass spectrometry (MS) apparatus, device, or system configured to perform a desired MS technique. Thus, as a further example, the upstream device 12 may be an ion source and the downstream device 18 may be an ion detector, and the other devices 14 and 16 may represent one or more other components such as ion storage or trapping devices, mass sorting or analyzing devices, collision cells or other fragmenting devices, ion optics and other ion guiding devices, etc. Thus, for example, the ion guide may be utilized before a mass analyzer (e.g., as a Q0 device), or itself as an RF/DC mass analyzer, or as a collision or reaction cell (e.g., as a Q2 device) positioned after a first mass analyzer and before a second mass analyzer. Accordingly, the ion guide may be evacuated, or may be operated in a regime where collisions occur between ions and gas molecules (e.g., as a Q2 device in a high-vacuum GC-MS, an LC-MS, or an ICP-MS, etc.).

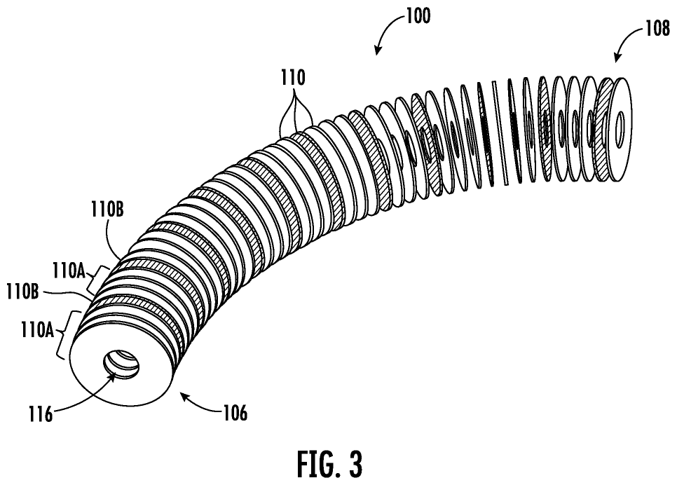

FIGS. 2 and 3 are top and perspective views, respectively, of an example of the ion guide 100 according to some embodiments. The ion guide 100 may, for example, be utilized as the ion guide 100 described above and illustrated in FIG. 1 and as part of the accompanying the ion processing system 10.

The ion guide includes a plurality of lenses 110 (e.g., electrostatic lenses) arranged in series along the curved central axis 102. The lenses 110 may be spaced apart and electrically isolated from one another.

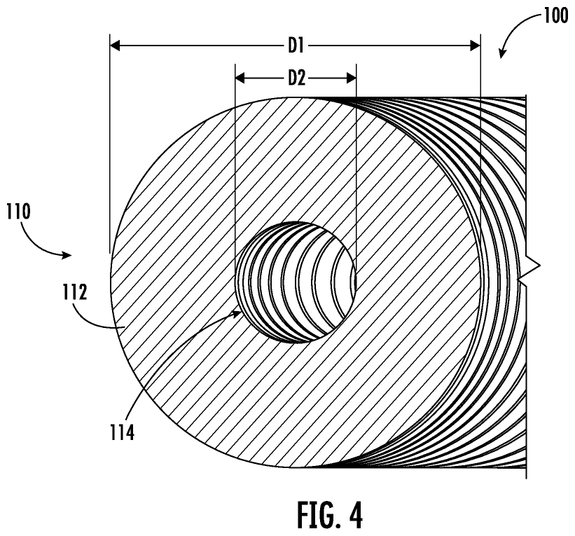

The lenses 110 may be disks or disk-shaped. Referring to FIG. 4, each lens 110 or disk includes a body 112 and a central opening 114. However, the lenses of the present technology are not limited to disks. For example, each lens may have a polygonal shape (e.g., square) with a central opening.

Referring again to FIGS. 2 and 3, the central openings 114 of the lenses 110 define a curved ion guide region 116. The curved ion guide region 116 begins at the ion entrance 106 and ends at the ion exit 108.

The curved central axis may be coextensive with an arc of a circular section. Other elliptical and hyperbolic curve shapes are contemplated.

An ion deflecting device or ion deflector 20 (also referred to herein as an ion bending device or ion bender) is configured to apply a radial DC electric field across the ion guide region 116 and along the curved central axis 102. Referring to FIGS. 1-3, the ion deflector 20 may include at least one DC voltage source 22, 24 that is configured to apply a positive DC voltage to at least some of the plurality of lenses 110 and a negative DC voltage to at least some of the plurality of lenses 110. FIG. 1 shows two DC voltage sources 22, 24. In some embodiments, the (first) voltage source 22 is configured to apply a positive DC voltage to at least some of the plurality of lenses 110 and the (second) voltage source 24 is configured to apply a negative DC voltage to at least some of the plurality of lenses 110. In some other embodiments, one DC voltage source or more than two DC voltage sources may be employed. It will be understood that such “sources” may include hardware, firmware, analog and/or digital circuitry, and/or software as needed to implement the desired functions of the devices.

A controller 26 may be used to coordinate/execute the actions and controls of the ion deflector 20 (and hence the DC voltage sources 22, 24). The controller 26 may also control or coordinate with the other apparatus in the system.

In some embodiments, for positive ions, the ion deflector 20 is configured to apply DC voltage in a repeating pattern including applying a positive DC voltage to a plurality of consecutive lenses 110A in the series followed by applying a negative DC voltage to at least one lens 110B in the series that directly follow the plurality of consecutive lenses 110A. In some embodiments, and as illustrated, the plurality of consecutive lenses 110A includes three lenses 110 in the series and the at least one lens 110B includes a single lens 110 in the series. However, in other embodiments, the plurality of consecutive lenses 110A includes two, four, or more lenses 110 in the series and/or the at least one lens 110B includes more than one consecutive lens 110 in the series. The number of the plurality of consecutive lenses 110A may increase as the initial kinetic energy of the ions increase.

The pattern may be reversed for negative ions. For example, for negative ions, the ion deflector 20 may be configured to apply DC voltage in a repeating pattern including applying a negative DC voltage to the plurality of consecutive lenses 110A in the series followed by applying a positive DC voltage to the at least one lens 110B in the series that directly follow the plurality of consecutive lenses 110A.

These types of repeating patterns have been demonstrated to work well for a large window of ion energies.

For positive ions, a positive DC voltage is applied to a majority of the lenses 110. For negative ions, a negative DC voltage is applied to a majority of the lenses 110.

The ion deflector 20 may include a plurality of DC voltage sources (e.g., voltage sources 22, 24 shown in FIG. 1) that are configured to concurrently or simultaneously apply a positive DC voltage to at least some of the plurality of lenses 110 (e.g., a first set) and a negative DC voltage to at least some of the plurality of lenses 110 (e.g., a second set).

The ion guide 100 does not rely on an RF field to bend ions along the curved ion guide region 116. Instead, the ion deflector 20 is configured to bend ions along the curved ion guide region 116 from the ion entrance 106 to the ion exit 108 only by DC voltage application and without applying an RF field.

Referring to FIG. 4, when the lens 110 is a disk, the body 112 of the disk may be continuous and surround (e.g., completely surround) the central opening 114. The body 112 of each disk may have an outer diameter D1 of between 10 and 40 mm and, in some embodiments, has an outer diameter D1 of about 19 mm. The central opening 114 of each disk may have a diameter D2 of between 2.5 and 8 mm and, in some embodiments, has a diameter D2 of about 6.35 mm.

In some embodiments, and as schematically shown in FIG. 1, the ion entrance 106 and the ion exit 108 define an angle of 180 degrees therebetween. In some other embodiments, and as shown in FIGS. 2 and 3, the ion entrance 106 and the ion exit 108 define an angle of 90 degrees therebetween. However, angles other than 90 and 180 degrees are contemplated. For example, in some embodiments, the angle may be in the range from 30 degrees to 180 degrees.

For the 90 degree curve ion guide (FIGS. 2 and 3), there may be between 40 and 60 lenses and, in some embodiments, there may be 46 lenses in the series. For the 180 degree curve ion guide (FIG. 1), there may be between 80 and 120 lenses and, in some embodiments, there may be 92 lenses in the series. These counts may be for the “curved portion” or “curved region” of the ion guide. Additional lenses may be used for focusing at the beginning and the end of the curve. In some embodiments, additional lenses may be used for focusing at an intermediate region and/or middle region of the curve.

In addition to the radial DC electric field, an axial DC electric field may be applied to the ion guide 100 along the central axis to control ion energy (e.g., axial ion velocity). An axial DC electric field may be particularly desirable in a case where ions being transmitted through the ion guide 100 experience collisions with neutral gas molecules (e.g., background gas). As appreciated by those skilled in the art, such collisions may be employed for ion fragmentation or for collisional cooling. A DC voltage source or sources may be utilized to generate the axial DC electric field. The DC voltage source or sources may communicate with one or more of the lenses 110 or with an external field generating device such as, for example, one or more other conductive members (e.g., resistive traces) positioned along the ion guide axis 102, such as outside the top and/or bottom of the ion guide 100, etc. This “axial” DC voltage source may be conceptualized as being a part of one or more of the functional elements 22, 24 schematically depicted in FIG. 1.

Additionally or alternatively, there could be a gradual increase or decrease in voltage over the entire series of lenses 110 or along each segment of lenses 110A. This can provide an electric field gradient that spans locally or along the entire length of the curve.

Rather than using an RF field, embodiments of the present technology use periodic negatively charged discs (for positive ions) angled to create a 90 degree or 180 degree turn to create the same trajectory that the ion would otherwise have with an RF field, with an added benefit that this geometry does not have the loss of sensitivity/transmission as a function of mass or energy. Simulations show that the concept can turn a wide range of masses and a wide range of energies. This shows to be an improvement over existing technologies because fewer ions are lost therefore increasing signal.

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items. When the term “about” or “substantially equal to” is used in the specification the intended meaning is that the value is plus or minus 5% of the specified value.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present technology are explained in detail in the specification set forth herein.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The foregoing is illustrative of the present technology and is not to be construed as limiting thereof Although a few example embodiments of this technology have been described, those skilled in the art will readily appreciate that many modifications are possible in the example embodiments without materially departing from the teachings and advantages of this technology. Accordingly, all such modifications are intended to be included within the scope of this technology as defined in the claims. The technology is defined by the following claims, with equivalents of the claims to be included therein.

What is claimed is:

1. An ion guide comprising:
a plurality of lenses arranged in series along a curved central axis, each lens comprising a body and a central opening, wherein the central openings of the plurality of lenses define a curved ion guide region, the curved ion guide region beginning at an ion entrance and ending at an ion exit; and
an ion deflector configured to apply a radial DC electric field across the ion guide region and along the curved central axis,
wherein the ion deflector comprises at least one DC voltage source that is configured to apply a positive DC voltage to at least some of the plurality of lenses and a negative DC voltage to at least some of the plurality of lenses.

2. The ion guide of claim 1 wherein the at least one DC voltage source is configured to apply DC voltage in a repeating pattern comprising applying one of a positive DC voltage and a negative DC voltage to a plurality of consecutive lenses in the series followed by applying the other one of a positive DC voltage and a negative DC voltage to at least one lens in the series that directly follow the plurality of consecutive lenses.

3. The ion guide of claim 2 wherein the at least one lens comprises a single lens in the series.

4. The ion guide of claim 2 wherein the plurality of consecutive lenses comprises at least three consecutive lenses in the series.

5. The ion guide of claim 1 wherein the ion entrance and the ion exit define an angle of 90 or 180 degrees therebetween.

6. The ion guide of claim 1 wherein each lens is disk shaped, and wherein the body of each lens is continuous and surrounds the central opening.

7. The ion guide of claim 6 wherein each of the lenses has an outer diameter of between 10 mm and 40 mm.

8. The ion guide of claim 6 wherein the central opening of each of the lenses has a diameter of between 2.5 mm and 8 mm.

9. The ion guide of claim 1 wherein the lenses are spaced apart and electrically isolated from one another.

10. The ion guide of claim 1 wherein the ion entrance and the ion exit define an angle of 90 degrees therebetween, and wherein the plurality of lenses comprises between 40 and 60 lenses.

11. The ion guide of claim 1 wherein the at least one DC voltage source comprises a plurality of DC voltage sources configured to simultaneously apply a positive DC voltage to at least some of the plurality of lenses and a negative DC voltage to at least some of the plurality of lenses.

12. An ion guide comprising:
a plurality of lenses arranged in series along a curved central axis, each lens comprising a body and a central opening, wherein the central openings of the plurality of lenses define a curved ion guide region, the curved ion guide region beginning at an ion entrance and ending at an ion exit; and
an ion bending or deflecting device configured to bend ions along the curved ion guide region from the ion entrance to the ion exit only by DC voltage application and without applying an RF field.

13. A method for guiding an ion through an ion guide, the method comprising:
transmitting the ion into a curved ion guide region of the ion guide, the ion guide comprising a plurality of lenses arranged in series along a curved central axis, each lens comprising a body and a central opening, wherein the central openings of the plurality of lenses define the curved ion guide region, the curved ion guide region beginning at an ion entrance and ending at an ion exit; and
providing an ion bending force to bend ions along the curved ion guide region from the ion entrance to the ion exit only by applying DC voltage to the plurality of lenses and without applying an RF field.

14. The method of claim 13 wherein providing an ion bending force comprises applying a positive DC voltage to at least some of the plurality of lenses and applying a negative DC voltage to at least some of the plurality of lenses.

15. The method of claim 14 wherein providing an ion bending force comprises applying DC voltage in a repeating pattern comprising applying one of a positive DC voltage and a negative DC voltage to a plurality of consecutive lenses in the series followed by applying the other one of a positive DC voltage and a negative DC voltage to at least one lens in the series that directly follow the plurality of consecutive lenses.

16. The method of claim 15 wherein the at least one lens comprises a single lens in the series.

17. The method of claim 15 wherein the plurality of consecutive lenses comprises at least three consecutive lenses in the series.

18. The method of claim 15 comprising applying an equal DC voltage to each of the plurality of consecutive lenses in the series.

19. The method of claim 15 comprising applying varying DC voltages to the plurality of consecutive lenses in the series.

20. The method of claim 14 comprising simultaneously applying a positive DC voltage to at least some of the plurality of lenses and applying a negative DC voltage to at least some of the plurality of lenses.
